(19) United States
(12) Patent Application Publication
(10) Pub. No.: US 2025/0217105 A1
(43) Pub. Date: Jul. 3, 2025

(54) FLOATING-POINT COMPUTING-IN-MEMORY DEVICE, EXPONENT COMPUTING MEMORY MODULE AND MANTISSA COMPUTING MEMORY MODULE

(71) Applicant: INDUSTRIAL TECHNOLOGY RESEARCH INSTITUTE, Hsinchu (TW)

(72) Inventors: Jian-Wei SU, Hsinchu City (TW); Peng-I MEI, Ji’an Township (TW); Chih-Sheng LIN, Tainan City (TW); Sih-Han LI, New Taipei City (TW); Shyh-Shyuan SHEU, Zhubei City (TW)

(73) Assignee: INDUSTRIAL TECHNOLOGY RESEARCH INSTITUTE, Hsinchu (TW)

(21) Appl. No.: 18/397,726

(22) Filed: Dec. 27, 2023

(51) Int. Cl. G06F 7/485

(52) U.S. Cl. CPC G06F 7/485

(57) ABSTRACT

A floating-point computing-in-memory device, an exponent computing memory module and a mantissa computing memory module are provided. The floating-point computing-in-memory device includes the exponent computing memory module and the mantissa computing memory module. The exponent computing memory module includes a plurality of weighting exponent memory circuits, a plurality of exponent computing circuits and a comparison circuit. The exponent computing circuits are used to obtain a plurality of exponent products. The mantissa computing memory module includes a bit shifting circuit, a plurality of weighting mantissa memory circuits, a plurality of mantissa computing circuits, a shift-and-addition circuit, a plurality of weighting sign memory circuits, a plurality of sign computing circuits and an addition circuit. The mantissa computing circuits and the shift-and-addition circuit are used to obtain a plurality of mantissa products. The sign computing circuits are used to obtain a plurality of sign products.

### TECHNICAL FIELD

The disclosure relates in general to a floating-point computing-in-memory device, an exponent computing memory module and a mantissa computing memory module.

### BACKGROUND

Computing-in-memory (CIM) is regarded as one of the effective technologies to solve the memory wall. It uses operations in the memory to reduce the number of data moves, which can greatly increase the computing speed to hundreds or even thousands of times of the traditional architecture. Today, a large part of the energy of large-scale AI networks (such as DNN) is consumed in data movement. Computing-in-memory (CIM) can significantly reduce the wasted energy, which can be said to be a future AI potential technology that both increases computing efficiency and reduces power consumption.

The potential of computing-in-memory (CIM) has led many manufacturers and research units to invest in and publish many novel technologies, but they might only perform integer operations, and the analog sensing used may cause problems such as noise or process variation. The currently proposed computing-in-memory (CIM) cannot support floating point operations. Therefore, researchers are working on developing a computing-in-memory architecture that supports floating point numbers.

### SUMMARY

The disclosure is directed to a floating-point computing-in-memory device, an exponent computing memory module and a mantissa computing memory module. The floating-point arithmetic circuit is integrated into the memory to avoid the input and output of data. As such, the calculation is faster, the power consumption is reduced, and the energy efficiency is improved.

According to one embodiment, a floating-point computing-in-memory device is provided. The floating-point computing-in-memory device includes an exponent computing memory module and a mantissa computing memory module. The exponent computing memory module includes a plurality of weighting exponent memory circuits, a plurality of exponent computing circuit and a comparison circuit. The weighting exponent memory circuits are used to store a plurality of exponent parts of a plurality of weighting data. The exponent computing circuits are used to execute an addition operation on a plurality of exponent parts of a plurality of inputting data and the exponent parts of the weighting data to obtain a plurality of exponent products. The comparison circuit is used to compare the exponent products to obtain a maximum exponent product. The mantissa computing memory module includes a bit shifting circuit, a plurality of weighting mantissa memory circuits, a plurality of mantissa computing circuits, a shift-and-addition circuit, a plurality of weighting sign memory circuits, a plurality of sign computing circuits and an addition circuit. The bit shifting circuit is used to shift a plurality of mantissa parts of the inputting data according to the maximum exponent product. The weighting mantissa memory circuits are used to store a plurality of mantissa parts of the weighting data. The mantissa computing circuits are used to execute a multiplication operation on the mantissa parts of the inputting data and the mantissa parts of the weighting data to obtain a plurality of mantissa intermediate products. The shift-and-addition circuit are used to shift and then sum up the mantissa intermediate products to obtain a plurality of mantissa products. The weighting sign memory circuit are used to store a plurality of sign parts of the weighting data. The sign computing circuits are used to execute an Exclusive-OR operation on a plurality of sign parts of the inputting data and the sign parts of the weighting data to obtain a plurality of sign products. The addition circuit is used to integrate the sign products, the maximum exponent products and the mantissa products to obtain an input-weighting sum-of-product.

According to another embodiment, an exponent computing memory module is provided. The exponent computing memory module includes a plurality of weighting exponent memory circuits, a plurality of exponent computing circuits and a comparison circuit. The weighting exponent memory circuits are used to store a plurality of exponent parts of a plurality of weighting data. The exponent computing circuit are used to execute an addition operation on a plurality of exponent parts of the inputting data and the exponent parts of the weighting data to obtain a plurality of exponent products. The comparison circuit is used to compare the exponent products to obtain a maximum exponent product.

According to an alternative embodiment, a mantissa computing memory module is provided. The mantissa computing memory module includes a plurality of weighting mantissa memory circuits, a plurality of mantissa computing circuits and a shift-and-addition circuit. The weighting mantissa memory circuits are used to store a plurality of mantissa parts of a plurality of weighting data. The mantissa computing circuits are used to execute a multiplication operation on a plurality of mantissa parts of a plurality of inputting data and the mantissa parts of the weighting data to obtain a plurality of mantissa intermediate products. The shift-and-addition circuit is used to shift and sum up the mantissa intermediate products to obtain a plurality of mantissa products.

### BRIEF DESCRIPTION OF THE DRAWINGS

FIG. 1 illustrates an example of a multiplication operation for floating point data according to an embodiment of the present disclosure.

FIG. 2 illustrates how to store the floating point data according to an embodiment of the present disclosure.

FIG. 3 illustrates an architectural diagram of a floating-point computing-in-memory device according to an embodiment of the present disclosure.

FIG. 4 illustrates the data flow of the floating-point computing-in-memory device according to one embodiment of the present disclosure.

FIG. 5 illustrates a schematic diagram of the weighting exponent memory circuits and the exponent computing circuit according to an embodiment of the present disclosure.

FIG. 6 illustrates a schematic diagram of the comparison circuit according to an embodiment of the present disclosure.

FIG. 7 illustrates a schematic diagram of the comparator according to an embodiment of the present disclosure.

FIG. 8 illustrates a schematic diagram of the bit shifting circuit according to an embodiment of the present disclosure.

FIG. 9 illustrates a schematic diagram of the mantissa computing circuit according to an embodiment of the present disclosure.

FIG. 10 illustrates a schematic diagram of the point-wise multiplier according to an embodiment of the present disclosure.

FIG. 11 illustrates the operation of the shift-and-addition circuit according to an embodiment of the present disclosure.

FIG. 12 illustrates a schematic diagram of the sign computing circuit according to an embodiment of the present disclosure.

FIG. 13 illustrates the multiplication operation of the integer data according to an embodiment of the present disclosure.

FIG. 14 illustrates the data flow of the integer operations performed by the floating-point computing-in-memory device according to one embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

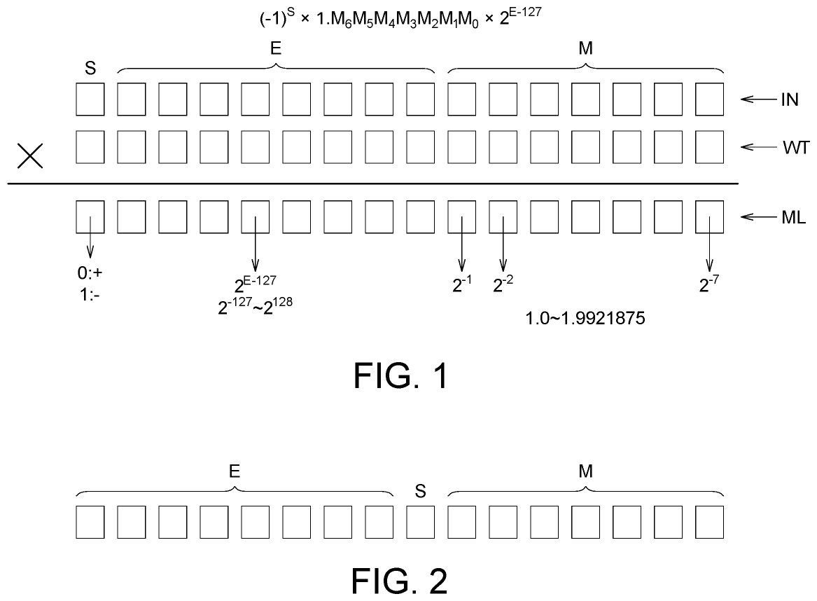

Please refer to FIG. 1, which illustrates an example of a multiplication operation for floating point data according to an embodiment of the present disclosure. The floating point data consists of a sign part S, an exponent part E and a mantissa part M. Taking the FP16 computing architecture (16-bit) as an example, the sign part S occupies 1 bit, the exponent part E occupies 8 bits, and the mantissa part M occupies 7 bits. If the mantissa part M (7 bits) are “M₆, M₅, M₄, M₃, M₂, M₁, M₀”, the floating point data is (−1)^{S}×1·M₆M₅M₄M₃M₂M₁M₀×2^{E-127}.

If the sign part S is “0”, it represents a positive value, if the sign part S is “1”, it represents a negative value. The expressible range of the exponent part E is 2⁻¹²⁷ to 2¹²⁸. The expressible range of the mantissa part M is 1.0 to 1.9921875.

As shown in the FIG. 1, both of the inputting data IN and the weighting data WT could be represented via the FP16 computing architecture. After executing a multiplication operation on the inputting data IN and the weighting data WT, a product result ML could be obtained. The product result ML would also be represented via the FP16 computing architecture. When the inputting data IN and the weighting data WT are executed the multiplication operation, an addition operation is executed on the exponent parts E, a multiplication operation is executed on the mantissa parts M, and an exclusive-OR operation is executed on the sign parts S.

Please refer to FIG. 2, which illustrates how to store the floating point data according to an embodiment of the present disclosure. In one embodiment, the exponent part E, the sign part S and the mantissa part M of the floating point data could be arranged in sequence and stored in the memory.

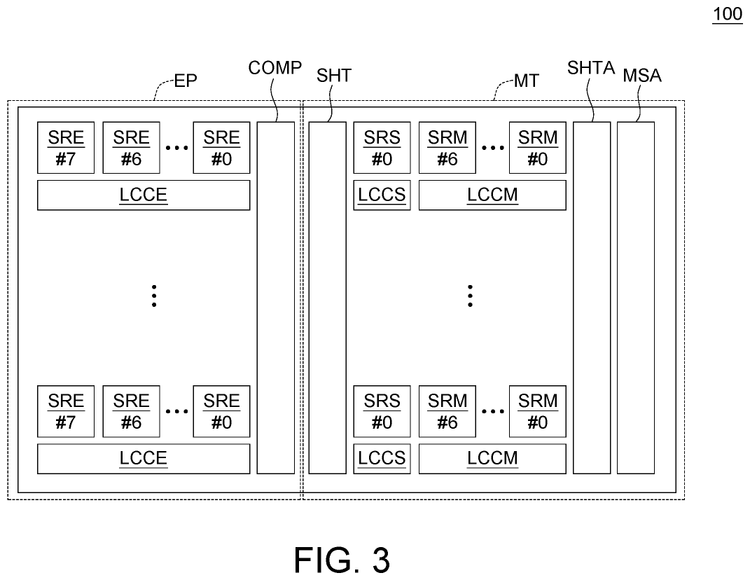

Please refer to FIG. 3, which illustrates an architectural diagram of a floating-point computing-in-memory device 100 according to an embodiment of the present disclosure. The floating-point computing-in-memory device 100 includes an exponent computing memory module EP and a mantissa computing memory module MT. The exponent computing memory module EP is used for storing and computing the exponent part E (shown in the FIG. 1) of the floating point data, the mantissa computing memory module MT is used for storing and computing the mantissa part M (shown in the FIG. 1) of the floating point data.

The exponent computing memory module EP includes a plurality of weighting exponent memory circuits SRE, a plurality of exponent computing circuits LCCE and a comparison circuit COMP. The mantissa computing memory module MT includes a bit shifting circuit SHT, a plurality of weighting sign memory circuits SRS, a plurality of sign computing circuits LCCS, a plurality of weighting mantissa memory circuits SRM, a plurality of mantissa computing circuits LCCM, a shift-and-addition circuit SHTA, and an addition circuit MSA.

The floating-point computing-in-memory device 100 integrates the storage units (such as the weighting exponent memory circuit SRE, the weighting sign memory circuit SRS, the weighting mantissa memory circuit SRM) and the computing units (such as the exponent computing circuit LCCE, the comparison circuit COMP, the bit shifting circuit SHT, the sign computing circuit LCCS, the mantissa computing circuit LCCM, the shift-and-addition circuit SHTA, the addition circuit MSA). Therefore, when executing the floating-point operations, frequent inputting and outputting of data could be avoided, so it has the advantage of fast operation, power consumption reducing, and energy efficiency improvement.

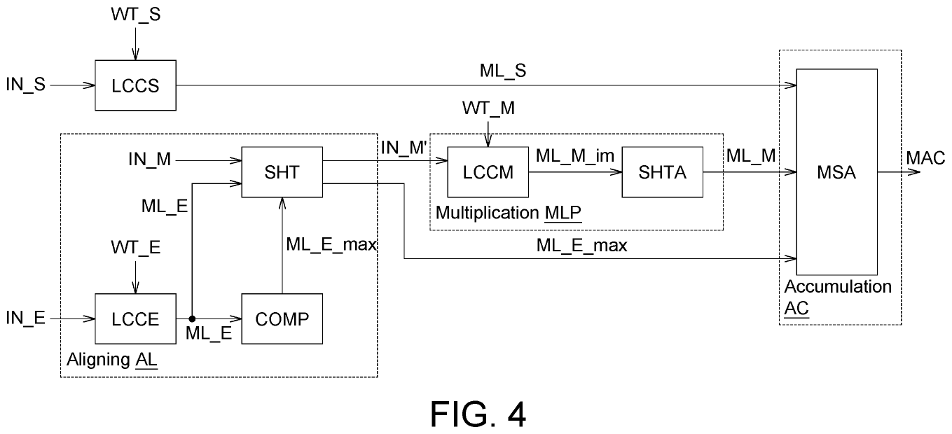

Please refer to FIGS. 3 and 4 at the same time. FIG. 4 illustrates the data flow of the floating-point computing-in-memory device 100 according to one embodiment of the present disclosure. The data flow of floating-point computing-in-memory device 100 for the floating-point operations includes an alignment AL for the exponent parts E (shown in the FIG. 1), a multiplication MLP for the mantissa parts M (shown in the FIG. 1), and an accumulation AC for the product results ML (shown in the FIG. 1). The alignment AL for the exponent parts E is completed by the exponent computing circuit LCCE of the exponent computing memory module EP, the comparison circuit COMP and the bit shifting circuit SHT of the mantissa computing memory module MT. The multiplication MLP of the mantissa parts M is completed by the mantissa computing circuit LCCM, the shift-and-addition circuit SHTA of the mantissa computing memory module MT. The accumulation AC of the multiplication results is completed by the addition circuit MSA of the mantissa computing memory module MT.

When executing the multiplication operations on the floating-point data, the addition operation will be executed on the exponent parts E. As shown in the FIG. 4, the exponent computing circuit LCCE is used to execute the addition operation on a plurality of exponent parts IN_E of a plurality of inputting data IN and a plurality of exponent parts WT_E of a plurality of weighting data WT respectively to obtain a plurality of exponent products ML_E. The exponent parts WT_E of the weighting data WT are stored in the weighting exponent memory circuit SRE of the FIG. 3.

The comparison circuit COMP is connected to the exponent computing circuit LCCE. The comparison circuit COMP is used to compare the exponent products ML_E to obtain a maximum exponent product ML_E_max.

The bit shifting circuit SHT is connected to the exponent computing circuit LCCE and the comparison circuit COMP. The bit shifting circuit SHT shifts the mantissa parts IN_M of the inputting data IN according to the maximum exponent product ML_E_max, to obtain the shifted mantissa parts IN_M′. The mantissa parts WT_M of the weighting data WT are stored in the weighting mantissa memory circuit SRM of FIG. 3.

The mantissa computing circuit LCCM is connected to the bit shifting circuit SHT. The mantissa computing circuit LCCM is used to execute a multiplication operation on the mantissa parts IN_M′ of the inputting data IN and the mantissa parts WT_M of the weighting data WT to obtain a plurality of mantissa intermediate products ML_M_im. The mantissa intermediate products ML_M_im are the multiplication results between each bit of the mantissa parts WT_M and the mantissa parts IN_M′ in the multiplication operation.

The shift-and-addition circuit SHTA is used to shift and sum up the mantissa intermediate products ML_M_im to obtain the mantissa product ML_M.

The sign computing circuit LCCS is used to execute an Exclusive-OR operation on the sign parts IN_S of the inputting data IN and the sign parts WT_S of the weighting data WT to obtain a sign product ML_S. The sign parts WT_S of the weighting data WT is stored in the weighting sign memory circuits SRS in FIG. 3.

The addition circuit MSA is used to integrate the sign product ML_S, the maximum exponent product ML_E_max and the mantissa products ML_M to obtain an inputting-weighting sum-of-product MAC.

The detailed structure and operation of each component are described in further detail below.

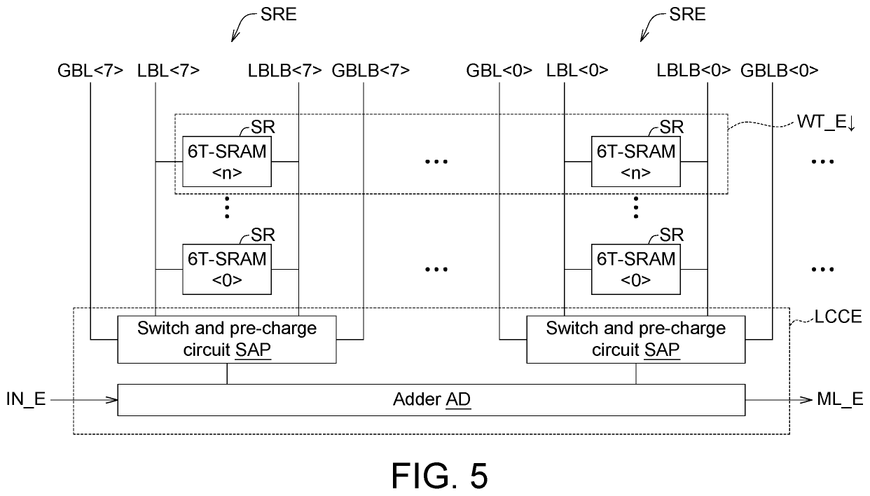

Please refer to FIG. 5, which illustrates a schematic diagram of the weighting exponent memory circuits SRE and the exponent computing circuit LCCE according to an embodiment of the present disclosure. The weighting exponent memory circuit SRE includes a plurality of static random-access memories (SRAM) SR. Each of the static random-access memories SR includes six transistors (i.e. 6T-SRAM). The weighting exponent memory circuit SRE has, for example, a plurality of global bit lines GBL<0> to GBL<7>, GBLB<0> to GBLB<7> and a plurality of local bit lines LBL<0> to LBL<7>, LBLB<0> to LBLB<7>. The static random-access memories SR arranged in one row store the exponent part WT_E of one weighting data WT. When the static random-access memories SR arranged in one row are turned on, the exponent part WT_E of one weighting data WT could be inputted to the exponent computing circuit LCCE via the local bit lines LBL<0> to LBL<7>.

The exponent computing circuit LCCE includes a plurality of switch and pre-charge circuits SAP and an adder AD. The switch and pre-charge circuits SAP are connected to the weighting exponent memory circuits SRE. The switch and pre-charge circuits SAP are used to receive the exponent part WT_E of the weighting data WT. The adder AD is connected to the switch and pre-charge circuits SAP to receive the exponent part WT_E of weighting data WT. The adder AD is used to execute the addition operation on the exponent part IN_E of inputting data IN and the exponent part WT_E of the weighting data WT to obtain the exponent product ML_E.

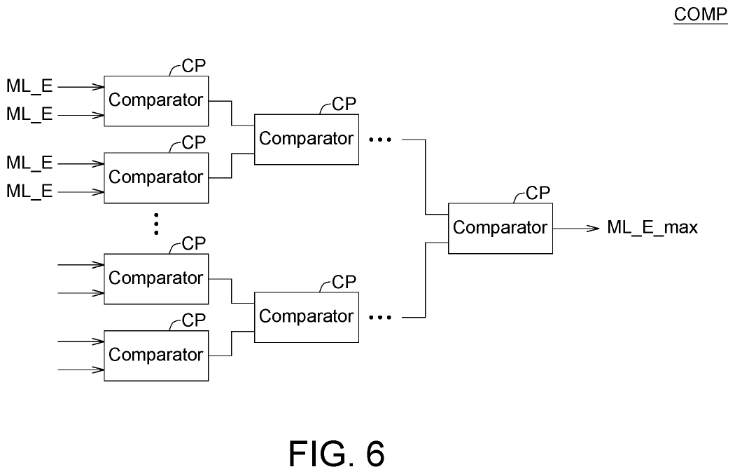

Please refer to FIG. 6, which illustrates a schematic diagram of the comparison circuit COMP according to an embodiment of the present disclosure. The comparison circuit COMP includes a plurality of comparators CP. The comparator CP is used to compare two exponent products ML_E. After hierarchical pairwise comparison, the maximum exponent product ML_E_max could be obtained.

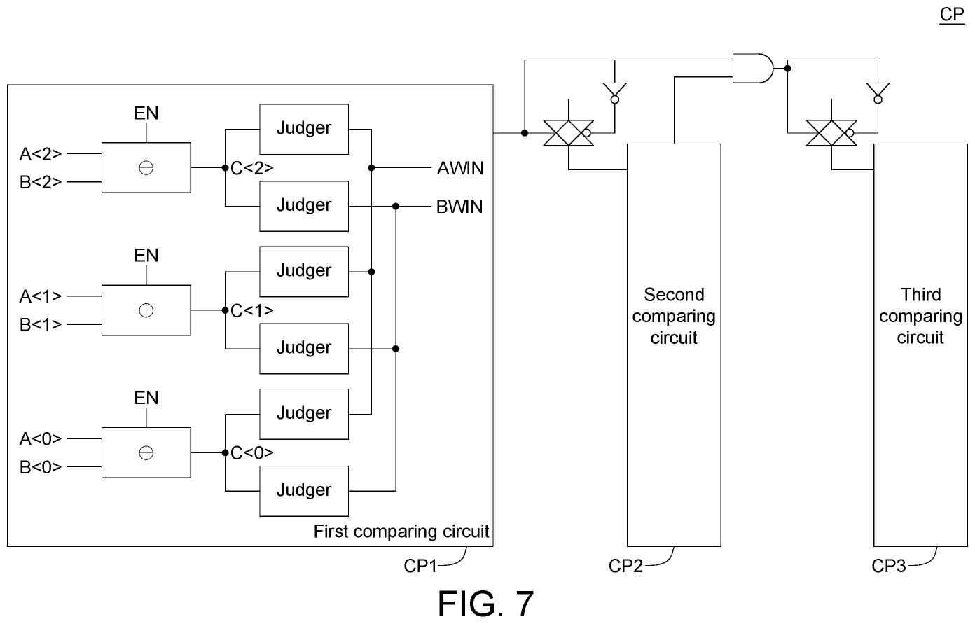

Please refer to FIG. 7, which illustrates a schematic diagram of the comparator CP according to an embodiment of the present disclosure. The comparator CP in this embodiment includes a first comparing circuit CP1, a second comparing circuit CP2 and a third comparing circuit CP3. The first comparing circuit CP1 is used to compare the front segment bits A<0> to A<2>, B<0> to B<2> of the exponent products ML_E. When the front segment bit A<2> is compared with the front segment bit B<2>, the exclusive-or judger is enabled through an enabling signal EN, and an exclusive-or result C<2> is outputted. The exclusive-or results C<2> to C<0> could be outputted a judgment result AWIN or a judgment result BWIN through the judgment of the judger. The judgment result AWIN means that the front segment bits A<0> to A<2> are larger than the front segment bits B<0> to B<2>. If which one is larger is determined by the first comparing circuit CP1, there is no need to activate the subsequent second comparing circuit CP2 and third comparing circuit CP3.

The second comparing circuit CP2 is connected to the first comparing circuit CP1. The second comparing circuit CP2 is used to compare the middle segment bits of the exponent products ML_E. If which one is larger is determined by the second comparing circuit CP2, there is no need to activate the subsequent third comparing circuit CP3.

The third comparing circuit CP3 is connected to the second comparing circuit CP2. The third comparing circuit CP3 is used to compare the last segment bits of the exponent products ML_E.

Through the three-stage judgment circuit design of the comparator CP, many comparisons for the exponent products ML_E could be made without turning on the second comparing circuit CP2 and third comparing circuit CP3, or without turning on the third comparing circuit CP3. Therefore, the power consumption can be greatly saved and the comparison speed can be accelerated.

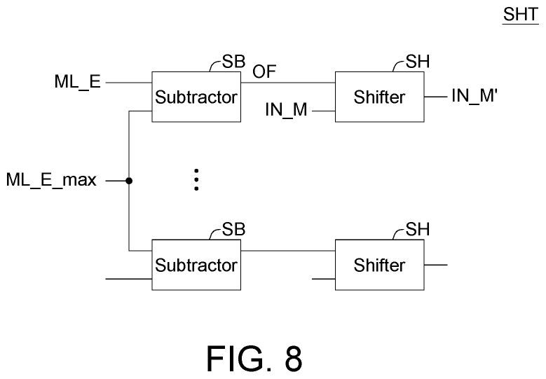

Please refer to FIG. 8, which illustrates a schematic diagram of the bit shifting circuit SHT according to an embodiment of the present disclosure. The bit shifting circuit SHT includes a plurality of subtractors SB and a plurality of shifters SH. The subtractors SB are connected to comparison circuit COMP. The subtractor SB is used to execute a subtracting operation on the maximum exponent product ML_E_max and the exponent product ML_E to obtain an offset OF.

The shifter SH is connected to the subtractor SB. The shifter SH is used to shift the mantissa part IN_M of the inputting data IN according to the offset OF to obtain the shifted mantissa part IN_M′.

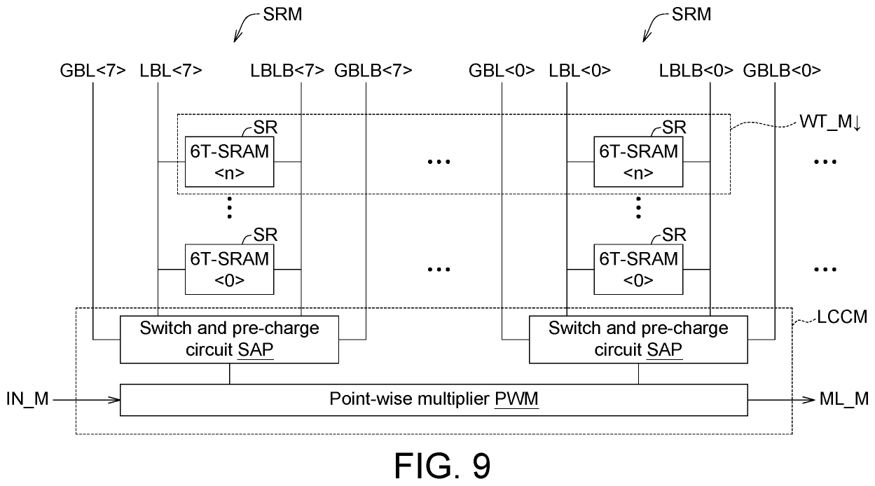

Please refer to FIG. 9, which illustrates a schematic diagram of the mantissa computing circuit LCCM according to an embodiment of the present disclosure. The weighting mantissa memory circuit SRM includes a plurality of static random-access memories (SRAM) SR. Each of the static random-access memories SR includes six transistors (i.e. 6T-SRAM). The weighting mantissa memory circuit SRM has, for example, a plurality of global bit lines GBL<0> to GBL<7>, GBLB<0> to GBLB<7> and a plurality of local bit lines LBL<0> to LBL<7>, LBLB<0> to LBLB<7>. The static random-access memories SR arranged in one row store the mantissa part WT_M of one weighting data WT. When the static random-access memories SR arranged in one row is turned on, the mantissa part WT_M of one weighting data WT could be inputted to the mantissa computing circuit LCCM via the local bit lines LBL<0> to LBL<7>.

The mantissa computing circuit LCCM includes a plurality of switch and pre-charge circuits SAP and a point-wise multiplier PWM. The switch and pre-charge circuit SAP is connected to the weighting mantissa memory circuit SRM. The switch and pre-charge circuits SAP are used to receive the mantissa part WT_M of the weighting data WT. The point-wise multiplier PWM is connected to the switch and pre-charge circuits SAP to receive the mantissa part WT_M of the weighting data WT. The point-wise multiplier PWM is used to execute the multiplication operation on the mantissa part IN_M of the input data IN and the mantissa part WT_M of the weighting data WT to obtain the mantissa product ML_M.

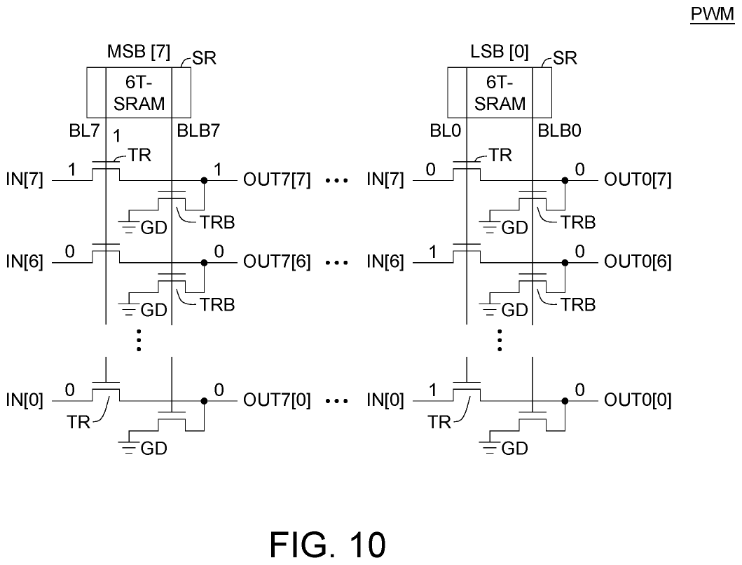

Please refer to FIG. 10, which illustrates a schematic diagram of the point-wise multiplier PWM according to an embodiment of the present disclosure. The point-wise multiplier PWM is composed of a plurality of transistors TR, TRB. The static random-access memories SR are used to store the bit values of the mantissa part WT_M of the weighting data WT. For example, the leftmost static random-access memory SR corresponds to the most significant bit MSB[7], and the rightmost static random-access memory SR corresponds to the least significant bit LSB[0].

The bit lines BL0 to BL7 of the static random-access memory SR of that stores the mantissa part WT_M of the weighting data WT_M are connected to the transistors TR connected in series. The bit lines BLB0 to BLB7 of the static random-access memory SR are connected to the transistors TRB connected in series. Two ends of the transistors TR are connected to the input ends IN[0] to IN[7] and the output ends OUT0[0] to OUT0[7]. Two ends of the transistors TRB are connected to the ground GD and the output ends OUT0[0] to OUT0[7]. The mantissa part IN_M of the inputting data IN is inputted from the input ends IN[0] to IN[7].

According to the circuit architecture of the point-wise multiplier PWM, when “1” in the mantissa part WT_M of the weighting data WT is inputted from the bit line BL7, and “1” in the mantissa part IN_M of the inputting data IN is inputted from the input end IN[7], the output end OUT7[7] would output “1”. When “1” in the mantissa part WT_M of the weighting data WT is inputted from the bit line BL7, and “0” in the mantissa part IN_M of the inputting data IN is inputted from the input end IN[6], the output end OUT7[6] would output “0”. When “0” in the mantissa part WT_M of the weighting data WT is inputted from the bit line BL0, and “0” in the mantissa part IN_M of the inputting data IN is inputted from the input end IN[7], the output end OUT0[7] would output “0”. When “0” in the mantissa part WT_M of the weighting data WT is inputted from the bit line BL0, and “1” in the mantissa part IN_M of the inputting data IN is inputted from the input end IN[6], the output end OUT0[6] would output “0”.

Through the circuit architecture of the above-mentioned point-wise multiplier PWM, the point-wise multiplication results between the mantissa part WT_M of the weighting data WT and the mantissa part IN_M of the inputting data IN could be obtained. The point-wise multiplication results are the aforementioned mantissa intermediate products ML_M_im.

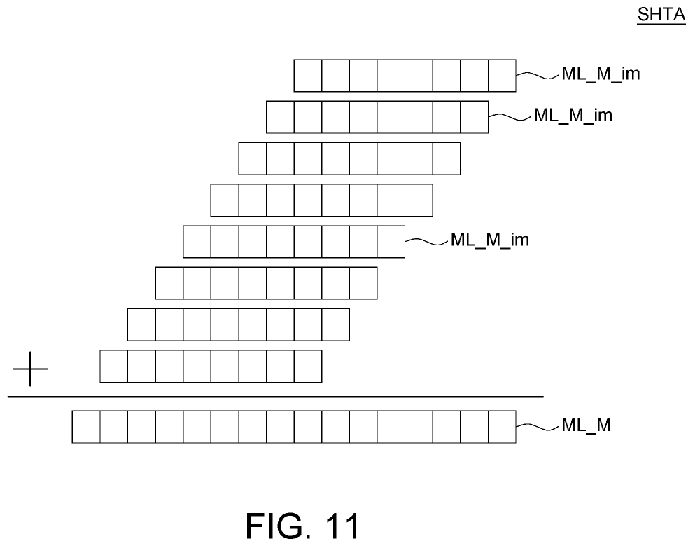

Please refer to FIG. 11, which illustrates the operation of the shift-and-addition circuit SHTA according to an embodiment of the present disclosure. The shift-and-addition circuit SHTA is used to shift the mantissa intermediate products ML_M_im and then sum up it together to obtain the mantissa product ML_M.

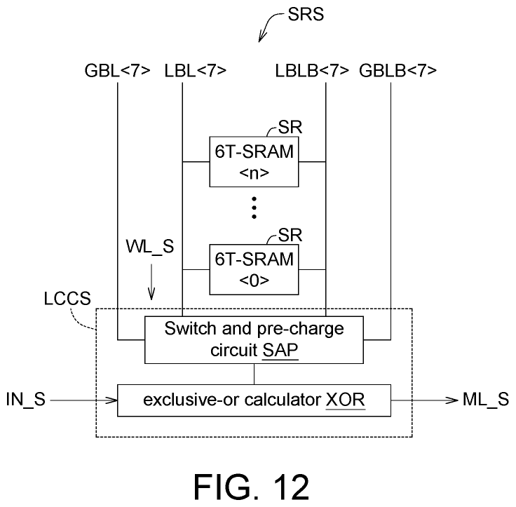

Please refer to FIG. 12, which illustrates a schematic diagram of the sign computing circuit LCCS according to an embodiment of the present disclosure. The weighting sign memory circuit SRS includes a plurality of static random-access memories (SRAM) SR. Each of the static random-access memories SR includes six transistors (i.e. 6T-SRAM). The weighting sign memory circuit SRS has, for example, two global bit lines GBL<7>, GBLB<7> and two local bit lines LBL<7>, LBLB<7>. One certain static random-access memory SR stores the sign part WT_S of one weighting data WT. When one static random-access memory SR is turned on, the sign part WT_S of one weighting data WT could be inputted to the sign computing circuit LCCS via the local bit line LBL<7>.

The sign computing circuit LCCS includes a switch and pre-charge circuit SAP and an exclusive-or calculator XOR.

The switch and pre-charge circuit SAP is connected to the weighting sign memory circuit SRS. The switch and pre-charge circuit SAP is used to receive the sign part WT_S of the weighting data WT. The exclusive-or calculator XOR is connected to the switch and pre-charge circuit SAP to receive the sign part WT_S of the weighting data WT. The exclusive-or calculator XOR is used to executed an exclusive-OR operation on the sign part IN_S of the inputting data IN and the sign part WT_S of the weighting data WT to obtain the sign product ML_S.

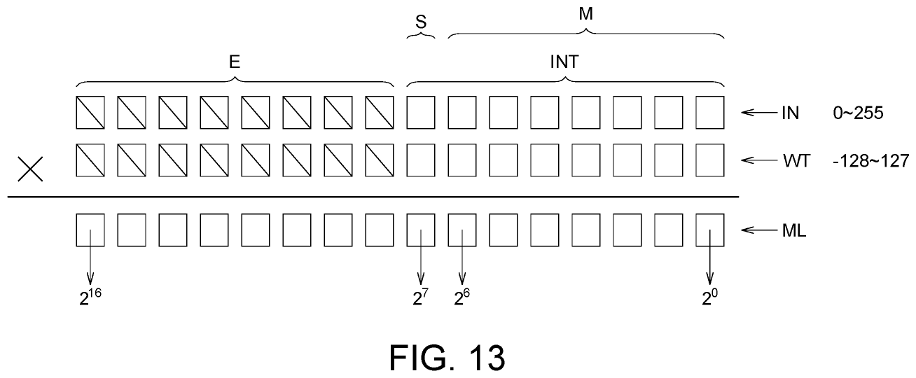

According to the above description, the floating-point computing-in-memory device 100 could support the FP16 computing architecture. In other embodiments, the floating-point computing-in-memory device 100 also supports the INT8 computing architecture. Please refer to FIG. 13, which illustrates the multiplication operation of the integer data according to an embodiment of the present disclosure. The sign part S and the mantissa part M of the floating point data form the integer part INT of the integer data. The exponent part E is not used. The integer part INT occupies 8 bits. The representable range of the inputting data IN is 0 to 255. The representable range of the weighting data WT is −128 to 127. After executing multiplication operation on the inputting data IN and the weighting data WT, the product result ML could be obtained.

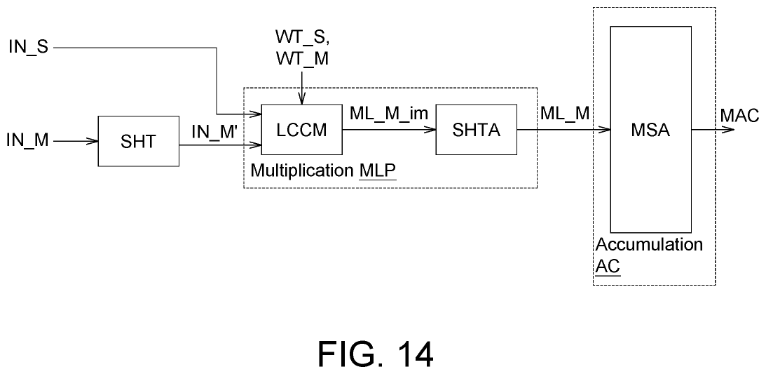

Please refer to FIG. 14, which illustrates the data flow of the integer operations performed by the floating-point computing-in-memory device 100 according to one embodiment of the present disclosure. The data flow of the floating-point computing-in-memory device 100 for the integer operations includes the multiplication MLP and the accumulation AC. The multiplication MLP is completed by the mantissa computing circuit LCCM and the shift-and-addition circuit SHTA of the mantissa computing memory module MT. The accumulation AC of the product result ML is completed by the addition circuit MSA of the mantissa computing memory module MT. In this way, the floating-point computing-in-memory device 100 could also support the INT8 computing architecture.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

According to the above embodiments, the floating-point computing-in-memory device 100 integrates the storage units (such as the weighting exponent memory circuit SRE, the weighting sign memory circuit SRS, the weighting mantissa memory circuit SRM) and the computing units (such as the exponent computing circuit LCCE, the comparison circuit COMP, the bit shifting circuit SHT, the sign computing circuit LCCS, the mantissa computing circuit LCCM, the shift-and-addition circuit SHTA, the addition circuit MSA). Therefore, when executing the floating-point operations, frequent inputting and outputting of data can be avoided, so it has the advantage of fast operation, power consumption reduction, and energy efficiency improvement.

The exponent computing module EP and/or the mantissa computing memory module MT proposed in this disclosure are within the scope of protection of this disclosure. If the exponent computing memory module EP of the present disclosure is implemented alone, and the remaining parts are combined with other circuit designs, it still does not deviate from the spirit and scope of the present disclosure. If the mantissa computing memory module MT of the present disclosure is implemented alone, and the remaining parts are combined with other circuit designs, it still does not deviate from the spirit and scope of the disclosure.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A floating-point computing-in-memory device, comprising:
an exponent computing memory module, including:
a plurality of weighting exponent memory circuits, used to store a plurality of exponent parts of a plurality of weighting data;
a plurality of exponent computing circuits, used to execute an addition operation on a plurality of exponent parts of a plurality of inputting data and the exponent parts of the weighting data to obtain a plurality of exponent products; and
a comparison circuit, used to compare the exponent products to obtain a maximum exponent product; and
a mantissa computing memory module, including:
a bit shifting circuit, used to shift a plurality of mantissa parts of the inputting data according to the maximum exponent product;
a plurality of weighting mantissa memory circuits, used to store a plurality of mantissa parts of the weighting data;
a plurality of mantissa computing circuits, used to execute a multiplication operation on the mantissa parts of the inputting data and the mantissa parts of the weighting data to obtain a plurality of mantissa intermediate products;
a shift-and-addition circuit, used to shift and then sum up the mantissa intermediate products to obtain a plurality of mantissa products;
a plurality of weighting sign memory circuits, used to store a plurality of sign parts of the weighting data;
a plurality of sign computing circuits, used to execute an Exclusive-OR operation on a plurality of sign parts of the inputting data and the sign parts of the weighting data to obtain a plurality of sign products; and
an addition circuit, used to integrate the sign products, the maximum exponent products and the mantissa products to obtain an input-weighting sum-of-product.

2. The floating-point computing-in-memory device according to claim 1, wherein each of the weighting exponent memory circuits includes a plurality of static random-access memories (SRAM).

3. The floating-point computing-in-memory device according to claim 2, wherein each of the static random-access memories includes six transistors.

4. The floating-point computing-in-memory device according to claim 1, wherein each of the exponent computing circuits includes:
a plurality of switch and pre-charge circuits, connected to the weighting exponent memory circuits, and used to receive the exponent parts of the weighting data; and
an adder, connected to the switch and pre-charge circuits, and used to receive the exponent parts of the weighting data, to execute the addition operation on the exponent parts of the inputting data and the exponent parts of the weighting data to obtain the exponent products.

5. The floating-point computing-in-memory device according to claim 1, wherein the comparison circuit is connected to the exponent computing circuits, and includes:
a plurality of comparators, used to compare two exponent products of the exponent products.

6. The floating-point computing-in-memory device according to claim 5, wherein each of the comparators includes:
a first comparing circuit, used to compare front segment bits of the exponent products;
a second comparing circuit, connected to the first comparing circuit, and used to compare middle segment bits of the exponent products;
a third comparing circuit, connected to the second comparing circuit, and used to compare last segment bits of the exponent products.

7. The floating-point computing-in-memory device according to claim 1, wherein the bit shifting circuit includes:
a plurality of subtractors, connected to the comparison circuit, and used to execute a subtracting operation on the maximum exponent product and the exponent products to obtain a plurality of offsets; and
a plurality of shifters, connected to the subtractors, and used to shift the mantissa parts of the inputting data according to the offsets.

8. The floating-point computing-in-memory device according to claim 1, wherein each of the weighting mantissa memory circuits includes a plurality of static random-access memories (SRAM).

9. The floating-point computing-in-memory device according to claim 1, wherein each of the mantissa computing circuits includes:
a plurality of switch and pre-charge circuits, connected to the weighting mantissa memory circuits, and used to receive the mantissa parts of the weighting data; and
a point-wise multiplier, connected to the switch and pre-charge circuits, and used to receive the mantissa parts of the weighting data, to execute a multiplication operation on the mantissa parts of the inputting data and the mantissa parts of the weighting data to obtain the mantissa products.

10. The floating-point computing-in-memory device according to claim 1, wherein each of the weighting sign memory circuits includes a plurality of static random-access memories (SRAM).

11. The floating-point computing-in-memory device according to claim 10, wherein each of the static random-access memories includes six transistors.

12. The floating-point computing-in-memory device according to claim 1, wherein each of the sign computing circuits includes:
a switch and pre-charge circuit, connected to the weighting sign memory circuit, and used to receive the sign parts of the weighting data; and
an exclusive-or calculator, connected to the switch and pre-charge circuit, and used to receive the sign parts of the weighting data, to execute the exclusive-or operation on the sign parts of the inputting data and the sign parts of the weighting data to obtain the sign products.

13. An exponent computing memory module, comprising:
a plurality of weighting exponent memory circuits, used to store a plurality of exponent parts of a plurality of weighting data;
a plurality of exponent computing circuits, used to execute an addition operation on a plurality of exponent parts of the inputting data and the exponent parts of the weighting data to obtain a plurality of exponent products; and
a comparison circuit, used to compare the exponent products to obtain a maximum exponent product.

14. The exponent computing memory module according to claim 13, wherein each of the weighting exponent memory circuits includes a plurality of static random-access memories (SRAM).

15. The exponent computing memory module according to claim 13, wherein each of the exponent computing circuits includes:
a plurality of switch and pre-charge circuits, connected to the weighting exponent memory circuits, and used to receive the exponent parts of the weighting data; and
an adder, connected to the switch and pre-charge circuits, and used to receive the exponent parts of the weighting data, to execute the addition operation on the exponent parts of the inputting data and the exponent parts of the weighting data to obtain the exponent products.

16. The exponent computing memory module according to claim 13, wherein the comparison circuit is connected to the exponent computing circuits, and includes:
a plurality of comparators, used to compare two exponent products of the exponent products.

17. The exponent computing memory module according to claim 16, wherein each of the comparators includes:
a first comparing circuit, used to compare front segment bits of the exponent products;
a second comparing circuit, connected to the first comparing circuit, and used to compare middle segment bits of the exponent products;
a third comparing circuit, connected to the second comparing circuit, and used to compare last segment bits of the exponent products.

18. A mantissa computing memory module, comprising:
a plurality of weighting mantissa memory circuits, used to store a plurality of mantissa parts of a plurality of weighting data;
a plurality of mantissa computing circuits, used to execute a multiplication operation on a plurality of mantissa parts of a plurality of inputting data and the mantissa parts of the weighting data to obtain a plurality of mantissa intermediate products; and
a shift-and-addition circuit, used to shift and sum up the mantissa intermediate products to obtain a plurality of mantissa products.

19. The mantissa computing memory module according to claim 18, wherein each of the weighting mantissa memory circuits includes a plurality of static random-access memories (SRAM).

20. The mantissa computing memory module according to claim 19, wherein each of the mantissa computing circuits includes:
a plurality of switch and pre-charge circuits, connected to the weighting mantissa memory circuits, and used to receive the mantissa parts of the weighting data; and
a point-wise multiplier, connected to the switch and pre-charge circuits, and used to receive the mantissa parts of the weighting data, to execute a multiplication operation on the mantissa parts of the inputting data and the mantissa parts of the weighting data to obtain the mantissa products.
